(19) United States
(12) Patent Application Publication
(10) Pub. No.: US 2019/0303067 A1
(43) Pub. Date: Oct. 3, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Hitoshi KATTA, Kanagawa (JP)

(73) Assignee: FUJI XEROX CO., LTD., Tokyo (JP)

(21) Appl. No.: 16/365,691

(22) Filed: Mar. 27, 2019

(30) Foreign Application Priority Data
Apr. 3, 2018 (JP) 2018-071305

(51) Int. Cl. G06F 3/12; H04W 4/20; H04W 4/029; H04W 4/021

(52) U.S. Cl. CPC G06F 3/1226; H04W 4/20; H04W 84/12; H04W 4/021; G06F 3/1204; H04W 4/029

(57) ABSTRACT

An information processing apparatus includes an obtaining unit and a starting unit. The obtaining unit obtains identification information included in receivable radio waves. The starting unit starts a software program which is usable in a place where a user is positioned. The place where the user is positioned is estimated from the identification information obtained by the obtaining unit.

### CROSS-REFERENCE TO RELATED APPLICATIONS

This application is based on and claims priority under 35 USC 119 from Japanese Patent Application No. 2018-071305 filed Apr. 3, 2018.

### BACKGROUND

### (i) Technical Field

The present disclosure relates to an information processing apparatus and a non-transitory computer readable medium.

### (ii) Related Art

Japanese Unexamined Patent Application Publication No. 2017-112618 discloses an information processing apparatus. This information processing apparatus searches for a partner communication device and generates connection information for connecting to the partner communication device based on device information obtained from a search result. The information processing apparatus then writes the generated connection information into a wireless communication tag.

Japanese Unexamined Patent Application Publication No. 2017-177768 discloses an information processing apparatus. This information processing apparatus obtains device information concerning an external device via wireless communication, and displays a screen provided by an application which causes the external device to perform a function. The information processing apparatus also displays a dialog screen for proposing performing a recommended function, based on the obtained device information.

### SUMMARY

Aspects of non-limiting embodiments of the present disclosure relate to an information processing apparatus and a non-transitory computer readable medium which make it possible to automatically start a software program that can be used in a place where a user using a certain service is positioned.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including an obtaining unit and a starting unit. The obtaining unit obtains identification information included in receivable radio waves. The starting unit starts a software program which is usable in a place where a user is positioned. The place where the user is positioned is estimated from the identification information obtained by the obtaining unit.

### BRIEF DESCRIPTION OF THE DRAWINGS

An exemplary embodiment of the present disclosure will be described in detail based on the following figures, wherein:

FIG. 1 is a schematic diagram illustrating an example of the configuration of an information processing system according to an exemplary embodiment;

FIG. 2 is a block diagram illustrating an example of the hardware configuration of a terminal apparatus according to an exemplary embodiment;

FIG. 3 is a block diagram illustrating an example of the functional configuration of the terminal apparatus;

FIG. 4 illustrates an example of information concerning the association between service set identifiers (SSIDs) assigned to services provided by some stores and apps for using multifunction copying machines installed in these stores;

FIG. 5 is a flowchart illustrating an example of the operation executed by the terminal apparatus when a user has entered a certain store and started a starting-app automatic selection app;

FIG. 6 illustrates an example of an operation screen for starting the starting-app automatic selection app;

FIG. 7 illustrates an example of an SSID list;

FIG. 8 illustrates an example of an operation screen of the terminal apparatus when an AAA-store multifunction copying machine app has started;

FIG. 9 illustrates another example of an SSID list;

FIG. 10 illustrates an example of an operation screen of the terminal apparatus when a BBB-store multifunction copying machine app has started;

FIG. 11 illustrates an example of a display screen of the terminal apparatus when a query is made to a user as to which one of the AAA-store multifunction copying machine app and the BBB-store multifunction copying machine app will be started; and

FIG. 12 illustrates a state in which, when a user with the terminal apparatus has entered a coffee shop, a coupon that the user can use in this coffee shop is automatically displayed.

### DETAILED DESCRIPTION

An exemplary embodiment of the disclosure will be described below in detail with reference to the accompanying drawings.

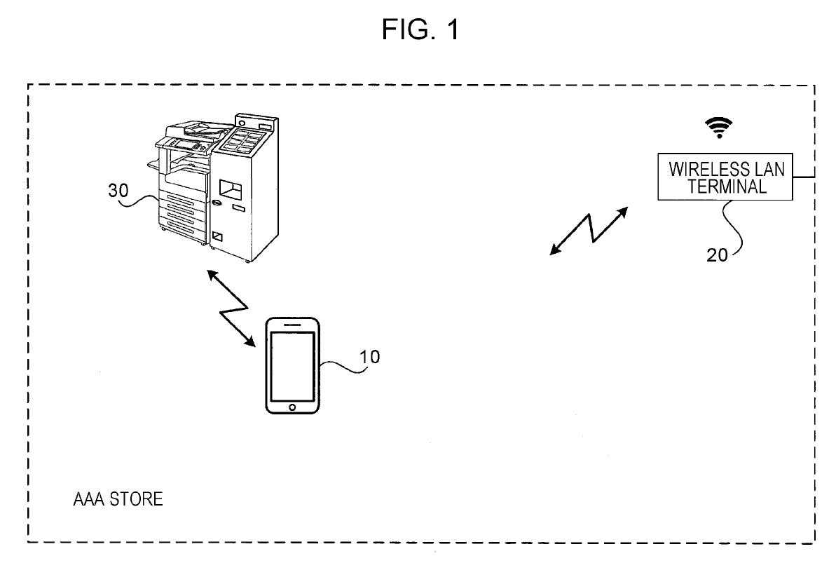

FIG. 1 illustrates an example of the configuration of an information processing system according to an exemplary embodiment.

As shown in FIG. 1, the information processing system according to the exemplary embodiment includes a terminal apparatus 10 and an image forming apparatus 30. The terminal apparatus 10 is a portable information processing apparatus that can be carried by a user. The image forming apparatus 30 is installed in a store, such as a convenience store.

The terminal apparatus 10 is a portable device, such as a smartphone, a tablet terminal, or a laptop personal computer (PC), connectable to a wireless local area network (LAN).

The image forming apparatus 30 is a multifunction device (multifunction copying machine) having multiple functions, such as printing, scanning, copying, and fax sending and receiving functions.

In the terminal apparatus 10, an AAA-store multifunction copying machine application program for using the image forming apparatus 30 installed in an AAA store has been downloaded. An application program will simply be called an app. By starting this app, the terminal apparatus 10 is able to perform various operations, such as providing a print instruction to the image forming apparatus 30 and receiving image data scanned by the image forming apparatus 30.

In the terminal apparatus 10, a BBB-store multifunction copying machine app for using an image forming apparatus installed in a BBB store and a CCC-store multifunction copying machine app for using an image forming apparatus installed in a CCC store have also been downloaded. By starting the BBB-store multifunction copying machine app or the CCC-store multifunction copying machine app, the terminal apparatus 10 is also able to perform various operations, such as providing a print instruction to an image forming apparatus and receiving image data scanned by an image forming apparatus installed in a BBB store or a CCC store.

The terminal apparatus 10 and the image forming apparatus 30 may be connected to each other via a wireless LAN, such as Wi-Fi (registered trademark) or near field communication (NFC) network, such as Bluetooth (registered trademark).

In FIG. 1, the image forming apparatus 30 is installed in the AAA store, which is one of the AAA chain stores operating the business under the same store name, such as chain convenience stores.

In the AAA chain stores, each store offers a free Wi-Fi service, which is a free service for connecting to a wireless LAN. A user registers for the use of the free Wi-Fi service in advance and can connect to a Wi-Fi network to use the Internet free of charge in an AAA store.

In the AAA store shown in FIG. 1, a wireless LAN terminal 20, which serves as a wireless-LAN access point, is installed.

Radio waves transmitted from a wireless-LAN access point include a service set identifier (SSID), which is an identifier for identifying this access point. The SSID is represented by a maximum of 32 alphanumeric characters. The SSID enables a device trying to connect to a wireless LAN to identify from which access point radio waves are being transmitted.

In this exemplary embodiment, it is assumed that radio waves transmitted from the wireless-LAN access point within the AAA chain stores include the SSID called “AAAspot”. When a user with the terminal apparatus 10 has entered an AAA store, it receives radio waves including the SSID called “AAAspot” and can connect to a wireless LAN to use the above-described free Wi-Fi service.

In this exemplary embodiment, the SSID called “BBB#free#wifi” is used for a free Wi-Fi service of BBB stores, which are different from AAA stores, and the SSID called “CCC#wi-fi” is used for a free Wi-Fi service of CCC stores, which are different from AAA stores and BBB stores.

In each of a BBB store and a CCC store, as well as in an AAA store, a multifunction copying machine is installed, and an app for using the multifunction copying machine is distributed to users. If AAA stores, BBB stores, and CCC stores are operated by different business operators, it is not likely that a user will be able to use the multifunction copying machine installed in a BBB store or a CCC store by using the AAA-store multifunction copying machine app.

If a user is confused whether it is in an AAA store, a BBB store, or a CCC store, the following situation may occur. The user starts the AAA-store multifunction copying machine app to try to operate the multifunction copying machine installed in a BBB store or a CCC store.

In this situation, the user may not understand the reason why it has failed to operate the multifunction copying machine, whether due to an error made by the user itself, a malfunction of the multifunction copying machine, or a malfunction of the terminal apparatus 10.

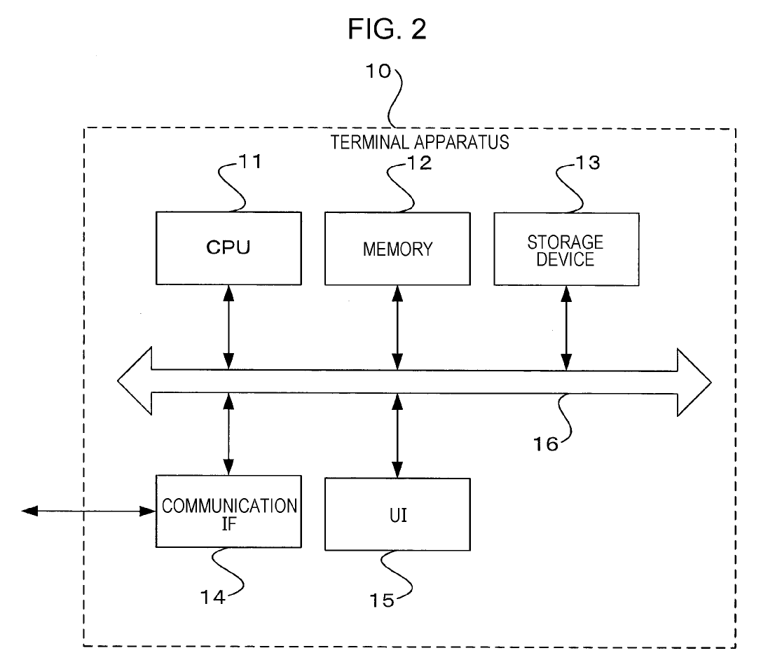

FIG. 2 illustrates an example of the hardware configuration of the terminal apparatus 10 in the information processing system of this exemplary embodiment.

As shown in FIG. 2, the terminal apparatus 10 includes a central processing unit (CPU) 11, a memory 12, a storage device 13, such as a hard disk drive (HDD), a communication interface (IF) 14, and a user interface (UI) 15. The communication IF 14 sends and receives data to and from an external device via a network. The UI 15 includes a touchscreen or a set of a liquid crystal display and a keyboard. The above-described elements are connected to each other via a control bus 16.

The CPU 11 executes predetermined processing based on a control program stored in the memory 12 or the storage device 13 so as to control the operation of the terminal apparatus 10. In this exemplary embodiment, the CPU 11 executes the control program stored in the memory 12 or the storage device 13. However, the control program may be downloaded as an app and be provided to the CPU 11.

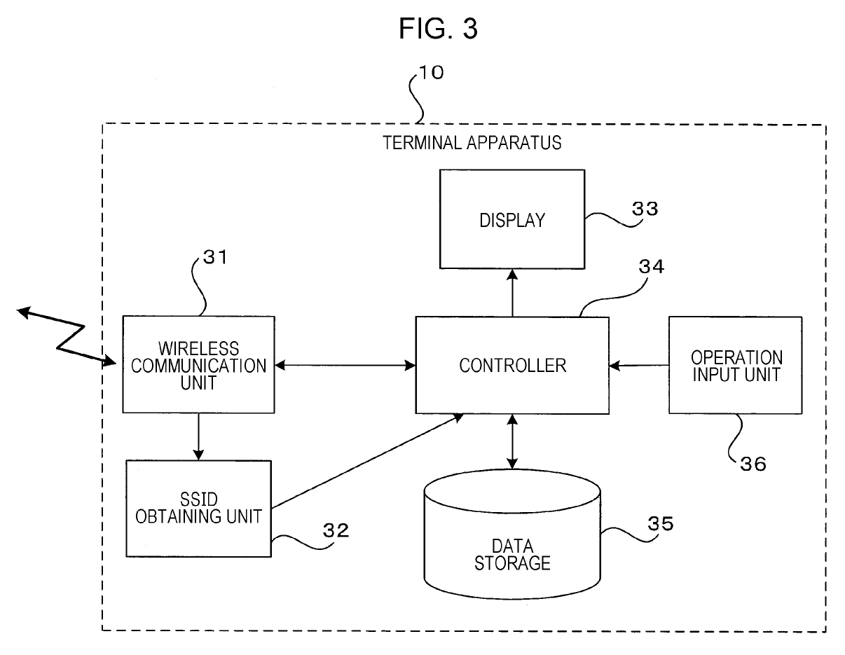

FIG. 3 is a block diagram illustrating an example of the functional configuration of the terminal apparatus 10 implemented as a result of the CPU 11 executing the above-described control program.

As shown in FIG. 3, the terminal apparatus 10 includes a wireless communication unit 31, an SSID obtaining unit 32, a display 33, a controller 34, a data storage 35, and an operation input unit 36.

The wireless communication unit 31 sends and receives data to and from the image forming apparatus 30 and the wireless LAN terminal 20 via a wireless communication network.

The SSID obtaining unit 32 obtains SSIDs, which are identification information included in radio waves that are receivable by the wireless communication unit 31. More specifically, the SSID obtaining unit 32 obtains SSIDs from radio waves received by the wireless communication unit 31, that is, radio waves transmitted from the wireless LAN terminal 20.

The operation input unit 36 receives various operations input by a user. The display 33 displays various items of information under the control of the controller 34.

The controller 34 provides a certain service to a user, based on the operation input from the user via the operation input unit 36. More specifically, the controller 34 provides the following service. Upon receiving an instruction to print image data from a user, the controller 34 sends the image data to the image forming apparatus 30 via the wireless communication unit 31 and instructs the image forming apparatus 30 to print the image data. Hereinafter, this service will be called the multifunction copying machine service.

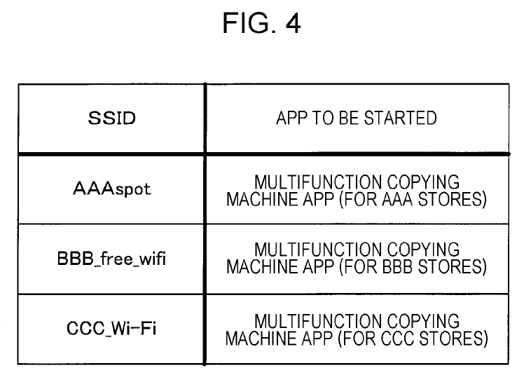

The data storage 35 stores data to be used by the controller 34 to execute control operations. For example, the data storage 35 stores image data, such as photo images, to be printed by the image forming apparatus 30 and image data scanned by the image forming apparatus 30. The data storage 35 also stores information, such as that shown in FIG. 4, concerning the association between SSIDs assigned to a free Wi-Fi service of AAA stores, that of BBB stores, and that of CCC stores and apps for using the multifunction copying machines installed in AAA stores, those in BBB stores, and those in CCC stores.

That is, the data storage 35 stores the SSIDs included in radio waves received by the wireless communication unit 31 and the apps for using the services provided in the stores where the corresponding SSIDs are obtained in association with each other.

In the terminal apparatus 10, a starting-app automatic selection app for automatically selecting a multifunction copying machine app to be started is installed. This app is used for estimating (determining) the type of store where a user is positioned from the SSID obtained from received radio waves and for automatically selecting the multifunction copying machine app associated with the estimated type of store.

When a user has started the starting-app automatic selection app and entered a certain store, the controller 34 estimates the app which can be used in the store where the user is positioned from the SSID obtained by the SSID obtaining unit 32, and starts this app.

More specifically, the controller 34 starts the app which is stored in the data storage 35 in association with the SSID obtained by the SSID obtaining unit 32, as the app which can be used in the store where the user is positioned.

That is, the controller 34 estimates the type of store where the user is positioned from the SSID obtained by the SSID obtaining unit 32 and starts the app which can be used in this store. For example, when the user has started the starting-app automatic selection app and entered an AAA store, if the SSID obtained by the SSID obtaining unit 32 is the SSID of the AAA store, that is, “AAAspot”, the controller 34 estimates that the user is in an AAA store. The controller 34 then starts the AAA-store multifunction copying machine app which can be used in the AAA store.

In an area where multiple stores are located closely, a user may receive radio waves, not only from the access point in a store where the user is positioned, but also from that in another store.

If multiple apps are usable in a store where the user is estimated to be positioned, the controller 34 may present the multiple apps to the user and start the app selected by the user.

For example, if two SSIDs called “AAAspot” and “BBB#free#wifi” are obtained by the SSID obtaining unit 32, the controller 34 presents the AAA-store multifunction copying machine app and the BBB-store multifunction copying machine app to the user. The controller 34 then starts the app selected by the user.

If no apps usable in a store where the user is estimated to be positioned are found, the controller 34 may supply information indicating that no services are available to the user.

For example, if a user has entered a certain store, which is neither an AAA store, nor a BBB store, nor a CCC store, and started the starting-app automatic selection app, the user is unable to use any service by using the apps installed in the terminal apparatus 10. The controller 34 thus informs the user that neither of the AAA-store multifunction copying machine service, nor the BBB-store multifunction copying machine service, nor the CCC-store multifunction copying machine service is available.

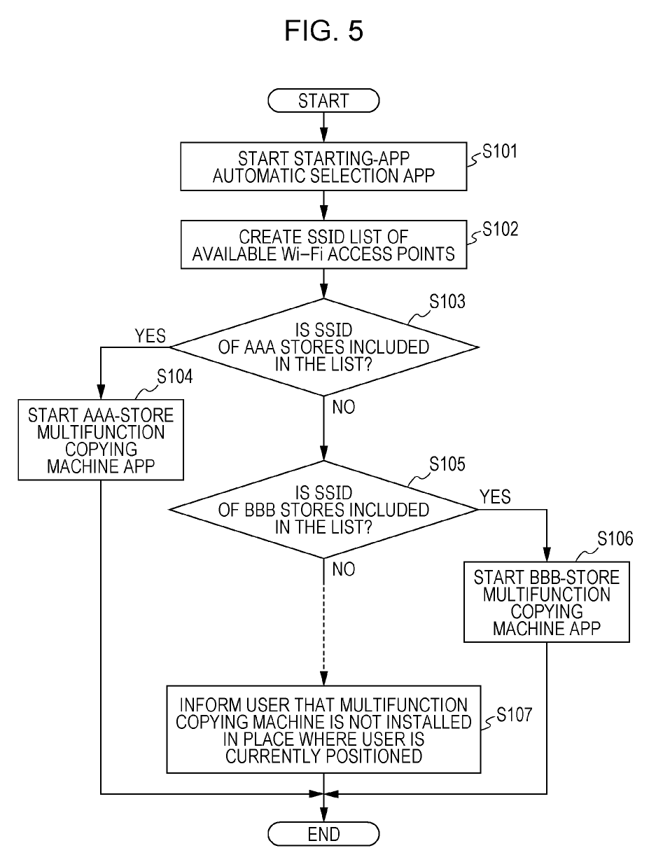

The operation of the information processing system according to the exemplary embodiment will be described below with reference to FIGS. 5 through 11.

FIG. 5 is a flowchart illustrating an example of the operation executed by the terminal apparatus 10 when a user has entered a certain store and started the above-described starting-app automatic selection app.

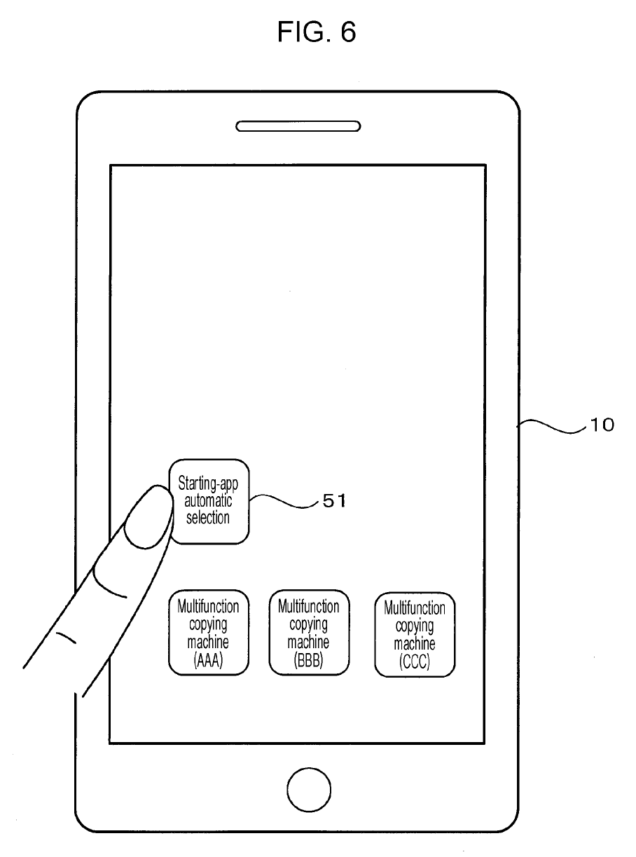

In step S101, after having entered a certain store, the user first touches an icon 51 on the operation screen of the terminal apparatus 10 to start the starting-app automatic selection app, as shown in FIG. 6. As shown in FIG. 6, the AAA-store multifunction copying machine app, BBB-store multifunction copying machine app, and CCC-store multifunction copying machine app have been installed in the terminal apparatus 10.

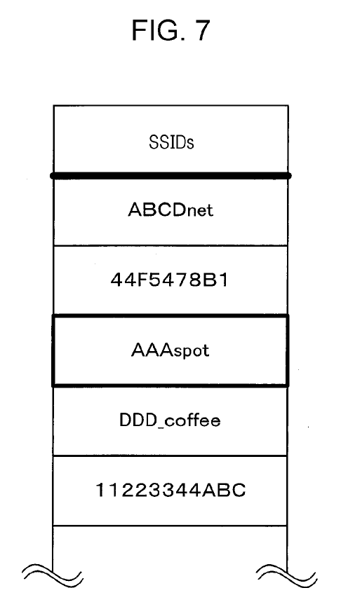

When the starting-app automatic selection app has started, the wireless communication unit 31 receives radio waves transmitted from the store that the user has entered. Then, the SSID obtaining unit 32 obtains SSIDs from the radio waves received by the wireless communication unit 31. In step S102, the controller 34 creates a list of the SSIDs obtained by the SSID obtaining unit 32, that is, a list of available Wi-Fi access points. An example of the SSID list is shown in FIG. 7.

The controller 34 then judges in step S103 whether “AAAspot”, which is the SSID of AAA stores, is included in the list created in step S102.

For example, in the SSID list shown in FIG. 7, the SSID called “AAAspot” is included. The controller 34 thus determines that the user is in an AAA store (YES in step S103), and starts the AAA-store multifunction copying machine app in step S104.

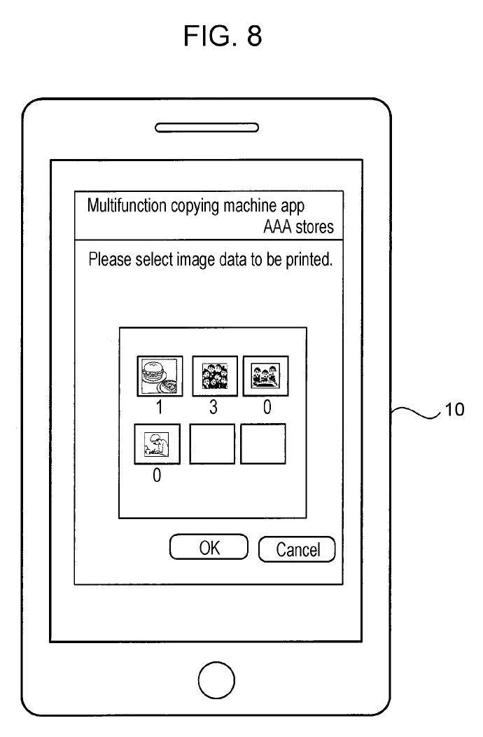

An example of the operation screen of the terminal apparatus 10 displayed when the AAA-store multifunction copying machine app has started is shown in FIG. 8. In the example in FIG. 8, the AAA-store multifunction copying machine app that can be used in the AAA store where the user is currently located has started, and the user can use this app to receive the service provided by using the image forming apparatus 30 installed in the AAA store.

That is, the user merely starts the starting-app automatic selection app without being aware of whether it is in an AAA store, a BBB store, or a CCC store, and then, the app that can be used in the store where the user is currently positioned is automatically started.

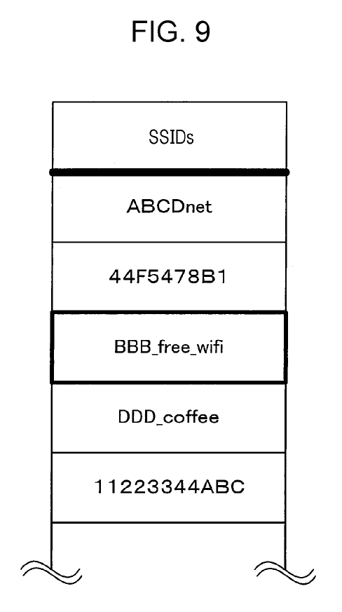

An explanation will be given of a case in which a list of SSIDs obtained by the SSID obtaining unit 32 is that shown in FIG. 9.

In the SSID list shown in FIG. 9, “AAAspot” is not included, but “BBB#free#wifi”, which is the SSID of BBB stores for providing a free Wi-Fi service, is included.

In this case, the SSID called “AAAspot” is not included in the list, and the controller 34 determines that the user is not in an AAA store (NO in step S103). The controller 34 then judges in step S105 whether “BBB#free#wifi”, which is the SSID of BBB stores, is included in the list.

In the example of the list in FIG. 9, the SSID called “BBB#free#wifi” is included. The controller 34 thus determines that the user is in a BBB store (YES in step S105) and starts the BBB-store multifunction copying machine app in step S106.

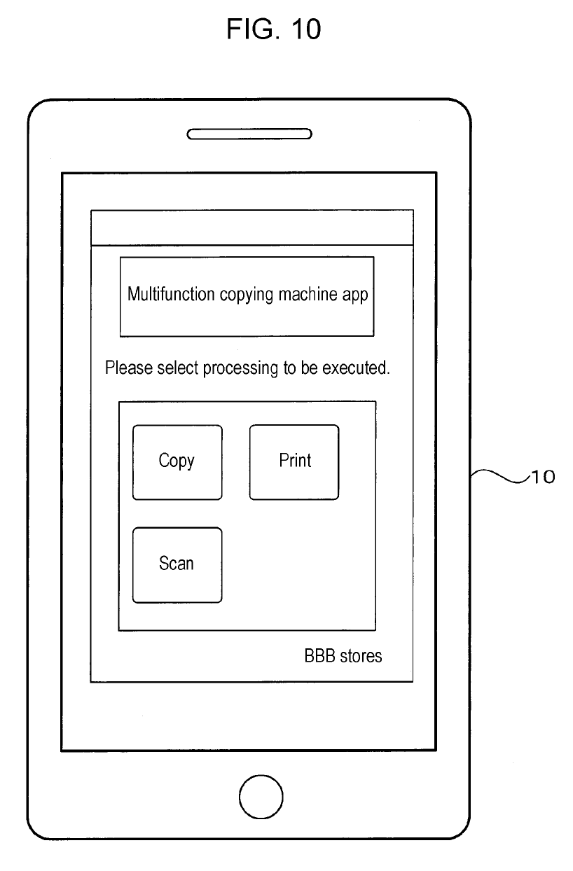

An example of the operation screen of the terminal apparatus 10 displayed when the BBB-store multifunction copying machine app has started is shown in FIG. 10. In the example in FIG. 10, the BBB-store multifunction copying machine app that can be used in the BBB store where the user is currently positioned has started, and the user can use this app to receive the service provided by using an image forming apparatus installed in the BBB store.

If neither of “AAAspot” nor “BBB#free#wifi” is included in the list, the controller 34 judges whether “CCC#wi-fi”, which is the SSID of CCC stores, is included in the list. If “CCC#wi-fi” is included in the list, the controller 34 starts the CCC-store multifunction copying machine app.

If neither of “AAAspot”, nor “BBB#free#wifi”, nor “CCC#wi-fi” is stored in the list, in step S107, the controller 34 informs the user via the display 33, for example, that a multifunction copying machine is not installed in the place where the user is currently positioned and it is not possible to use the multifunction copying machine service.

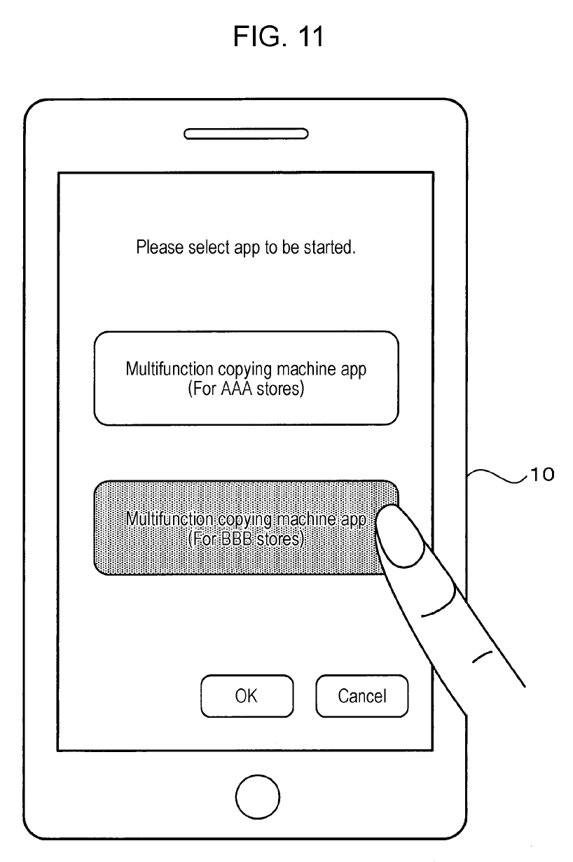

If both of “AAAspot” and “BBB#free#wifi” are included in the list obtained by the SSID obtaining unit 32, the controller 34 displays a screen such as that shown in FIG. 11 to query the user as to which one of the AAA-store multifunction copying machine app and the BBB-store multifunction copying machine app will be started. The controller 34 then starts the multifunction copying machine app selected by the user. In FIG. 11, the user has selected the BBB-store multifunction copying machine app.

Modified examples will be described below. In the above-described exemplary embodiment, based on the SSIDs obtained by the SSID obtaining unit 32, an app to be started is selected among plural apps installed in the terminal apparatus 10 and is automatically started. Alternatively, the place where a user is positioned may be estimated from the SSIDs obtained by the SSID obtaining unit 32, and information concerning a service available in the estimated place may be displayed.

In this case, the controller 34 causes the display 33 to display information concerning a service available in the estimated place where the user is positioned.

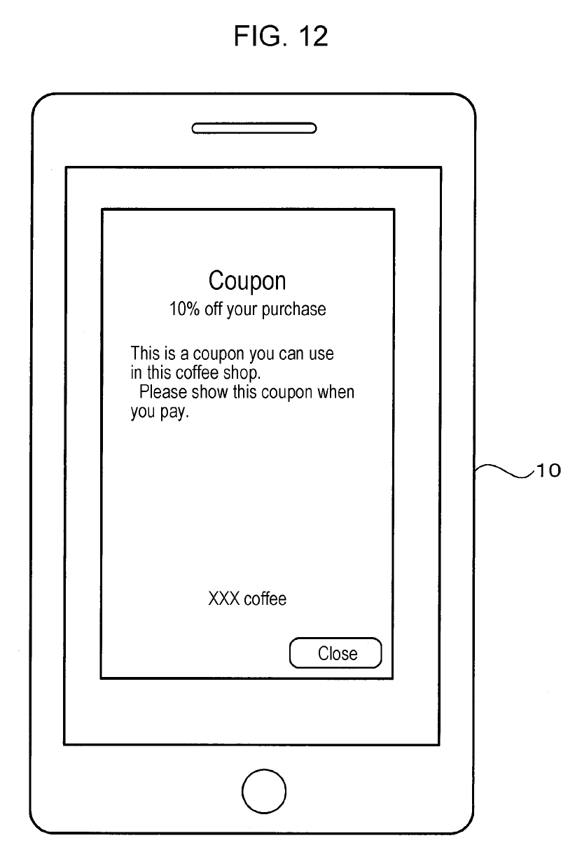

As a result of the controller 34 performing such control, if, for example, a user with the terminal apparatus 10 has entered a coffee shop, a coupon that the user can use in this coffee shop may automatically be displayed, as shown in FIG. 12.

In another example, if the terminal apparatus 10 has received the SSID of a free Wi-Fi service provided by an airport, various items of information, such as airport information and instructions, may automatically be displayed.

However, to allow the controller 34 to perform such control, it is necessary to store display data to be displayed on the operation screen in association with the corresponding SSID in advance. For example, the display data is stored in a server device in association with this SSID, and when the terminal apparatus 10 has obtained the SSID, it sends the SSID to the server device. Then, the server device returns the display data associated with this SSID to the terminal apparatus 10. If the amount of display data to be stored in association with the SSID is small, the display data may be stored in the terminal apparatus 10.

In the above-described exemplary embodiment, the service provided by the terminal apparatus 10 is that for using a multifunction copying machine (image forming apparatus) installed in a store. However, this is only an example. The present disclosure may be applicable to any case in which a user receives a service provided in a store by using the terminal apparatus 10.

In the above-described exemplary embodiment, based on the SSIDs obtained by the SSID obtaining unit 32, an app to be started is selected among plural apps installed in the terminal apparatus 10 and is automatically started. However, this is only an example. The present disclosure may be applicable to a case in which an app for using a certain service is started based on the SSIDs obtained by the SSID obtaining unit 32.

In the above-described exemplary embodiment, an SSID, which is an identifier for a wireless-LAN access point, is used for estimating the location or the type of store where a user is positioned, and then, the controller 34 judges whether the user is able to utilize a certain service. However, this is only an example. The present disclosure may be applicable to any case if it is possible to estimate the location or the type of store where a user is positioned by identification information included in radio waves transmitted from a store.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
an obtaining unit that obtains identification information included in receivable radio waves; and
a starting unit that starts a software program which is usable in a place where a user is positioned, the place where the user is positioned being estimated from the identification information obtained by the obtaining unit.

2. The information processing apparatus according to claim 1, further comprising:
a storage that stores identification information included in radio waves and a software program in association with each other, the software program being used for utilizing a service provided in a place where the identification information is obtained,
wherein the starting unit starts a software program which is stored in the storage in association with identification information obtained by the obtaining unit, as the software program which is usable in the place where the user is positioned.

3. The information processing apparatus according to claim 1, wherein:
the place where the user is positioned is a type of store where the user is positioned; and
the starting unit starts a software program which is usable in the store where the user is positioned.

4. The information processing apparatus according to claim 1, wherein, if a plurality of software programs are usable in the place where the user is positioned, the starting unit presents the plurality of software programs to the user and then starts a software program selected by the user.

5. The information processing apparatus according to claim 1, further comprising:
an informing unit that informs the user that no service is available if no software program which is usable in the place where the user is positioned is found.

6. The information processing apparatus according to claim 3, wherein a service to be used by the user is a service for using an image forming apparatus installed in the store.

7. The information processing apparatus according to claim 1, wherein the software program is an application program for using a certain service.

8. An information processing apparatus comprising:
an obtaining unit that obtains identification information included in receivable radio waves; and
a display that displays information concerning a service available in a place where a user is positioned, the place where the user is positioned being estimated from the identification information obtained by the obtaining unit.

9. The information processing apparatus according to claim 1, wherein the identification information is an identifier for an access point of a wireless local area network.

10. The information processing apparatus according to claim 8, wherein the identification information is an identifier for an access point of a wireless local area network.

11. The information processing apparatus according to claim 9, wherein the identifier is a service set identifier for an access point of a wireless local area network.

12. The information processing apparatus according to claim 10, wherein the identifier is a service set identifier for an access point of a wireless local area network.

13. A non-transitory computer readable medium storing a program causing a computer to execute a process, the process comprising:
obtaining identification information included in receivable radio waves; and
starting a software program which is usable in a place where a user is positioned, the place where the user is positioned being estimated from the obtained identification information.
